(19) United States
(12) Patent Application Publication
(10) Pub. No.: US 2024/0395456 A1
(43) Pub. Date: Nov. 28, 2024

(54) METHOD FOR PRODUCING RFeB-BASED MAGNET, AND ALLOY FOR GRAIN BOUNDARY DIFFUSION PROCESS USED IN THE METHOD

(71) Applicant: DAIDO STEEL CO., LTD., Nagoya-shi (JP)

(72) Inventors: Mayu KIKUCHI, Nagoya-shi (JP); Yusuke YOSHIMI, Nagoya-shi (JP); Hirokazu KUBO, Nagoya-shi (JP); Michihide NAKAMURA, Nagoya-shi (JP)

(21) Appl. No.: 18/667,436

(22) Filed: May 17, 2024

(30) Foreign Application Priority Data
May 22, 2023 (JP) 2023-084189

(51) Int. Cl. H01F 41/02; H01F 1/057

(52) U.S. Cl. CPC H01F 41/0293; H01F 1/0577

(57) ABSTRACT

The present invention relates to a method for producing an RFeB-based magnet, the method including: a base material preparation step of preparing a base material made of a sintered body of an RFeB-based alloy or a hot-deformed body of the RFeB-based alloy; an adhesion substance preparation step of preparing an adhesion substance containing an R_{Hd}Cu alloy that includes Cu and a heavy rare earth element R_{Hd} to be diffused and that has a content of Cu of 20 mass % or more and 40 mass % or less; an adhesion step of adhering the adhesion substance to a surface of the base material; and a heating step of heating the base material to which the adhesion substance has been adhered to a predetermined temperature at which the heavy rare earth element R_{Hd} to be diffused is diffused into the base material through a grain boundary of the base material.

### CROSS-REFERENCE TO RELATED APPLICATIONS

This application is based on and claims priority under 35 USC 119 from Japanese Patent Application No. 2023-084189 filed on May 22, 2023, the content of which is incorporated herein by reference.

### TECHNICAL FIELD

The present invention relates to a method for producing an RFeB-based sintered magnet or an RFeB-based hot-deformed magnet (collectively referred to as an “RFeB-based magnet”) containing a rare earth element (hereinafter, referred to as “R”), iron (Fe), and boron (B) as main constituent elements, and an alloy used in the method. The RFeB-based sintered magnet refers to a magnet obtained by orienting an RFeB-based raw material powder in a magnetic field, followed by sintering; and the RFeB-based hot-deformed magnet refers to a magnet obtained by performing hot pressing work on the RFeB-based raw material powder, followed by performing hot deformation process, to thereby align orientations of crystal axes of crystal grains.

### BACKGROUND ART

The RFeB-based magnet has an advantage that various magnetic properties such as a remanence are better than other permanent magnets. An initial RFeB-based magnet had a disadvantage that a coercivity, which is one of the magnetic properties, is relatively low. But then it is found that the coercivity can be improved by allowing one or more of Dy, Tb, and Ho (hereinafter, these three kinds of elements are collectively referred to as “heavy rare earth elements”) to be present in the vicinity of a surface of a crystal grain of the RFeB-based magnet.

The heavy rare earth element has almost no adverse effect on the magnetic properties other than the coercivity as long as the heavy rare earth element is present in the vicinity of the surface of the crystal grain of the RFeB-based magnet. However, the heavy rare earth element has a disadvantage that the remanence is reduced in the case where a large amount of the heavy rare earth element is present inside the crystal grain. Therefore, in the related art, as a method for producing an RFeB-based magnet, so-called grain boundary diffusion method has been used (for example, Patent Literatures 1 and 2). In the grain boundary diffusion method, after a base material made of a sintered body obtained by sintering a raw material powder of an RFeB-based magnet is prepared, an adhesion substance containing an alloy including a heavy rare earth element is adhered to a surface of the base material, followed by heating to a temperature within a predetermined temperature range (typically 700° C. to 1000° C.). Then, the heavy rare earth element in the adhesion substance is diffused into the sintered body through a grain boundary of a crystal grain of the sintered body serving as the base material, and enters in the vicinity of the surface of the crystal grain, but hardly enters into the inside of the crystal grain. Accordingly, the heavy rare earth element is sufficiently present in the vicinity of the surface of the crystal grain and is hardly present inside the crystal grain, and the RFeB-based magnet can be obtained in which the coercivity is high and a decrease in remanence can be prevented.

Patent Literature 1 discloses that a TbCu alloy including 86 mass % of Tb and 14 mass % of Cu as an element other than a heavy rare earth element is used as the adhesion substance. Patent Literature 2 discloses that a TbCu alloy including 85.4 mass % of Tb and 14.6 mass % of Cu is used as the adhesion substance (Patent Literature 2 describes a TbCu alloy as a comparative example with a case where a TbCuAl alloy including Tb, Cu and Al is used). In Patent Literature 1, Cu is considered to have a role of preventing a heavy rare earth element from entering into a crystal grain, and in Patent Literature 2, Cu is considered to have a role of blocking magnetic interaction between crystal grains by being present at a grain boundary.
Patent Literature 1: JP2020-092121A
Patent Literature 2: JP2020-013975A
Patent Literature 3: JP2006-019521A

Non-Patent Literature 1: Keiko Hioki, Atsushi Hattori, “Development of Dy-Saving Nd—Fe—B-Based Hot-Deformed Magnet Using Ultra Rapidly Cooled Powder as Raw Material”, Sokeizai, Volume: 52, Issue: 8, Page: 19 to 24, General Incorporated Foundation of SOKEIZAI CENTER, Published in August, 2011

### SUMMARY OF INVENTION

It is known that, generally, a coercivity and a squareness ratio of magnet decrease as the temperature increases. Here, the squareness ratio is a value represented by a ratio Hₖ/H_{cj} of an inverse magnetic field Hₖ to a coercivity H_{cj} when magnetization becomes 90% of a remanence in a second quadrant of a magnetization curve (demagnetization curve). The larger the value of the squareness ratio, the smaller the variation in magnetization with the variation in magnetic field and the more stable the characteristics are in a variable magnetic field. Since the temperature of a drive motor for a car rises to about 130° C. during use, it is required to increase the coercivity and the squareness ratio at a high temperature of about 130° C. in order to use an RFeB-based magnet in such a motor.

An object of the present invention is to provide a method for producing an RFeB-based magnet in which a coercivity and a squareness ratio at a high temperature can be made larger than those in the related art.

A method for producing an RFeB-based magnet in order to solve the above problems is a method for producing an RFeB-based magnet, the method including:
a base material preparation step of preparing a base material made of a sintered body of an RFeB-based alloy including a rare earth element R, Fe, and B or a hot-deformed body of the RFeB-based alloy;
an adhesion substance preparation step of preparing an adhesion substance containing an R_{Hd}Cu alloy that includes Cu and a heavy rare earth element R_{Hd} to be diffused and that has a content of Cu of 20 mass % or more and 40 mass % or less, the heavy rare earth element R_{Hd} to be diffused being any one of or a mixture of two or more of Dy, Tb, and Ho;
an adhesion step of adhering the adhesion substance to a surface of the base material; and
a heating step of heating the base material to which the adhesion substance has been adhered to a predetermined temperature at which the heavy rare earth element R_{Hd} to be diffused is diffused into the base material through a grain boundary of the base material.

An R_{Hd}Cu alloy is an alloy that is allowed to include inevitable impurities, but otherwise includes only Cu and a heavy rare earth element R_{Hd} to be diffused. Therefore in the case where inevitable impurities are ignored, when a content of Cu is determined, a content of the heavy rare earth element R_{Hd} to be diffused is uniquely determined. For example, when the content of Cu is 20 mass %, the content of the heavy rare earth element R_{Hd} to be diffused is 80 mass %, and when the content of Cu is 40 mass %, the content of the heavy rare earth element R_{Hd} to be diffused is 60 mass %.

Through experiments conducted by the present inventors, it has been revealed that when a content of Cu in an R_{Hd}Cu alloy to be contained in an adhesion substance used in a grain boundary diffusion process is set to 20 mass %, which is higher than 14 mass % to 14.6 mass % described in Patent Literatures 1 and 2, a coercivity and squareness ratio at 130° C. of an RFeB-based magnet subjected to the grain boundary diffusion process can be improved. It has been revealed that in the case where the content of Cu in the R_{Hd}Cu alloy is increased to more than 20 mass %, such a large coercivity and squareness ratio can be obtained when the content of Cu is up to 40 mass %, but when the content of Cu exceeds 40 mass %, the coercivity and squareness ratio are decreased. Therefore, in the method for producing an RFeB-based magnet according to the present invention, the grain boundary diffusion process is performed using an adhesion substance containing an R_{Hd}Cu alloy having a content of Cu of 20 mass % or more and 40 mass % or less.

According to experiments conducted by the present inventors, further, by setting the content of Cu in the R_{Hd}Cu alloy to 20 mass % or more and 40 mass % or less, absolute values of a temperature coefficient α of remanence at 130° C. and a temperature coefficient β of coercivity at 130° C. can be made smaller than those in the cases where the content of Cu is less than 20 mass % and exceeds 40 mass %. Here, the temperature coefficient α (or β) is a value representing a slope in a graph with temperature as the horizontal axis and remanence (or coercivity) as the vertical axis. The smaller the absolute value thereof, the smaller the change in remanence (or coercivity) with temperature change. Particularly, the temperature coefficient α of remanence decreases significantly (i.e., increases in absolute terms) when the content of Cu in the R_{Hd}Cu alloy is less than 20 mass %, and the temperature coefficient β of coercivity decreases significantly (i.e., increases in absolute terms) when the content of Cu exceeds 40 mass %. Therefore, by setting the content of Cu to 20 mass % or more and 40 mass % or less, stable characteristics can be obtained in both remanence and coercivity. The content of Cu is preferably 20 mass % or more and 30 mass % or less.

In the present invention, an order of a base material preparation step and an adhesion substance preparation step is not limited. One of the base material preparation step and the adhesion substance preparation step may be performed first, and the other may be performed later, or both steps may be performed simultaneously.

In the present invention, a form of the adhesion substance is not particularly limited. For example, an ingot, foil, powder, or the like of the R_{Hd}Cu alloy may be adhered to (brought into contact with) a surface of the base material as it is, or an adhesion substance in which an R_{Hd}Cu alloy powder is dispersed in a dispersant such as a liquid or grease may be prepared, and then the adhesion substance may be adhered to the surface of the base material. In the case of using a powder of the R_{Hd}Cu alloy, the higher the content of Cu in the R_{Hd}Cu alloy, the more difficult it is to crush the alloy ingot, and when the content of Cu exceeds 40 mass %, it becomes difficult to reduce a particle diameter (for example, to 10 μm or less in median value). In the present invention, since the content of Cu is set to 40 mass % or less, problems regarding crushing do not occur.

In the present invention, it is desirable that the base material has a content of C (carbon) of 0.10 mass % or less and a content of O (oxygen) of 0.10 mass % or less. It is more desirable that the contents of C and O are both 0.05 mass % or less. By reducing the content of C and O in the base material as described above, it is difficult for C and O to present in a grain boundary of the base material, and thus during a heating step, diffusion of the heavy rare earth element R_{Hd} to be diffused into the base material through the grain boundary can be prevented from being hindered by C and O. Therefore, since the heavy rare earth element R_{Hd} to be diffused easily spreads to the vicinity of the surface of the crystal grain in the base material, the coercivity can be further improved.

The alloy for grain boundary diffusion process according to the present invention is an alloy for grain boundary diffusion process, including an R_{Hd}Cu alloy that includes Cu and a heavy rare earth element R_{Hd} to be diffused, and that has a content of Cu of 20 mass % or more and 40 mass % or less, in which
the heavy rare earth element R_{Hd} to be diffused is any one of or a mixture of two or more of Dy, Tb, and Ho, and
the grain boundary diffusion process includes adhering the alloy for grain boundary diffusion process to a base material made of a sintered body of an RFeB-based alloy including a rare earth element R, Fe, and B or a hot-deformed body of the RFeB-based alloy, followed by heating the base material to a predetermined temperature, to thereby diffuse the heavy rare earth element R_{Hd} to be diffused into the base material through a grain boundary of the base material.

By the method for producing an RFeB-based magnet and the alloy for grain boundary diffusion process according to the present invention, an RFeB-based magnet having a coercivity and squareness ratio larger than that in the related art at a high temperature can be obtained.

### BRIEF DESCRIPTION OF DRAWINGS

FIG. 1 is a graph showing a relationship between a content of Cu in an alloy for grain boundary diffusion process used in a method for producing an RFeB-based magnet and a remanence Bᵣ of a produced RFeB-based sintered magnet in the present embodiment and Comparative Examples, which is obtained through an experiment at a temperature of 130° C.

FIG. 2 is a graph showing a relationship between the content of Cu in the alloy for grain boundary diffusion process used in the method for producing an RFeB-based magnet and a coercivity Hₑj of the produced RFeB-based sintered magnet in the present embodiment and Comparative Examples, which is obtained through an experiment at a temperature of 130° C.

FIG. 3 is a graph showing a relationship between the content of Cu in the alloy for grain boundary diffusion process used in the method for producing an RFeB-based magnet and a squareness ratio SQ of the produced RFeB-based sintered magnet in the present embodiment and comparative examples, which is obtained through an experiment at a temperature of 130° C.

FIG. 4 is a graph showing a relationship between the content of Cu in the alloy for grain boundary diffusion process used in the method for producing an RFeB-based magnet and a temperature coefficient α remanence of the produced RFeB-based sintered magnet in the present embodiment and Comparative Examples, which is obtained through an experiment at a temperature of 130° C.

FIG. 5 is a graph showing a relationship between the content of Cu in the alloy for grain boundary diffusion process used in the method for producing an RFeB-based magnet and a temperature coefficient β of coercivity of the produced RFeB-based sintered magnet in the present embodiment and Comparative Examples, which is obtained through an experiment at a temperature of 130° C.

### DESCRIPTION OF EMBODIMENTS

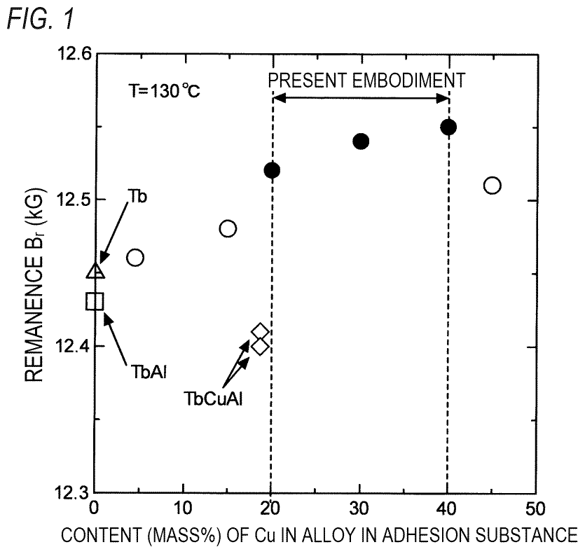

An embodiment of a method for producing an RFeB-based magnet and an alloy for grain boundary diffusion process according to the present invention will be described with reference to FIGS. 1 to 5. In the method for producing an RFeB-based magnet of the present embodiment, a base material preparation step, an adhesion substance preparation step, an adhesion step, and a heating step are performed. Either the base material preparation step or the adhesion substance preparation step may be performed first, or both steps may be performed simultaneously. The adhesion step is performed after the base material preparation step and the adhesion substance preparation step, and the heating step is performed after the adhesion step.

In the base material preparation step, a base material made of a sintered body of an RFeB-based alloy including a rare earth element R (typically, Nd or/and Pr which are light rare earth elements), Fe, and B or a hot-deformed body of the RFeB-based alloy is prepared. The sintered body of the RFeB-based alloy may be prepared by a press method in which an RFeB-based alloy powder serving as a raw material is subjected to press molding while being oriented by a magnetic field and then is sintered, or may be prepared by a press-less process (PLP) method in which the RFeB-based alloy powder is oriented by a magnetic field in a mold and then sintered as it is without press molding, as described in Patent Literature 3. The PLP method is preferable in that a coercivity can be further improved, and an RFeB-based sintered magnet body having a complicated shape can be prepared without machining. The RFeB-based hot-deformed magnet body can be prepared by a method described in Non-Patent Literature 1.

A composition ratio of R, Fe, and B is typically 2:14:1 in terms of atomic ratio, but the composition ratio may deviate somewhat from this ratio. Elements other than R, Fe, and B may be added. For example, a part of Fe may be substituted with Co and/or Ni, or an additive element such as Cu, Al, or Ga may be included. Inevitable impurities such as C, N, and O are also allowed to be included. A shape of the base material is not particularly limited, and may be, for example, a rectangular parallelepiped body, a shape in which rectangular parallelepiped body is curved into an arched shape, or a shape in which one of six surfaces of rectangular parallelepiped body is changed to a convex arcuate curved surface.

In the adhesion substance preparation step, an adhesion substance containing an R_{Hd}Cu alloy, which is an alloy for grain boundary diffusion process of the present embodiment, is prepared. The R_{Hd}Cu alloy includes Cu and a heavy rare earth element R_{Hd} to be diffused, and does not include elements other than R_{Hd} and Cu except for inevitable impurities. R_{Hd} included in the R_{Hd}Cu alloy is the heavy rare earth element, and only one kind of Dy, Tb, and Ho of or a mixture of two kinds or three kinds among Dy, Tb, and Ho. A content of R_{Hd} in the R_{Hd}Cu alloy is in a range of 60 mass % or more and 80 mass % or less, and the rest is a content of Cu. Accordingly, the content of Cu is 20 mass % or more and 40 mass % or less. A coercivity and a squareness ratio of the RFeB-based magnet at 130° C. can be increased by performing a grain boundary diffusion process as described below using the adhesion substance containing the R_{Hd}Cu alloy having such contents of R_{Hd} and Cu.

A form of the R_{Hd}Cu alloy contained in the adhesion substance can be an ingot, a foil, a powder, or the like. When producing a powdered R_{Hd}Cu alloy, the higher the content of Cu in the R_{Hd}Cu alloy, the more difficult it is to crush the alloy ingot. In the present embodiment, by setting the content of Cu to 40 mass % or less, a powdered R_{Hd}Cu alloy having a small particle diameter (for example, a median value of 10 m or less) can be easily produced. The powdered R_{Hd}Cu alloy may be used as an adhesion substance as it is, or may be used by being dispersed in a dispersant such as a liquid or grease. In Examples to be described later, a powdered R_{Hd}Cu alloy is mixed with silicone grease.

In the adhesion step, the adhesion substance produced in the adhesion substance preparation step is adhered to a surface of the base material produced in the base material preparation step. When using an ingot-shaped or foil-shaped adhesion substance, the adhesion substance is brought into contact with the surface of the base material. When using a powdered adhesion substance, the powdered adhesion substance may be adhered to the surface of the base material as it is, but it is preferable to adhere the powdered adhesion substance in a state of being dispersed in the dispersant as described above since it becomes difficult to peel off from the base material.

In the heating step, the base material is heated to a predetermined temperature in the state where the adhesion substance is adhered to the surface of the base material. A temperature during the heating is, for example, within a range of 600° C. to 1000° C. The predetermined temperature is not limited to this range, and may be any temperature as long as the heavy rare earth element R_{Hd} to be diffused is diffused into the base material through a grain boundary of the base material.

### Example

Hereinafter, Examples in which an RFeB-based magnet was produced using the method for producing an RFeB-based magnet and the alloy for grain boundary diffusion process according to the present embodiment and Comparative Examples will be described. In these Examples and Comparative Examples, base materials obtained by cutting sintered bodies of the RFeB-based alloy produced by a PLP method using RFeB-based magnet powders having the same composition into rectangular bodies of 24 mm×15 mm×9.4 mm were used. A composition of the sintered body of the RFeB-based alloy was as follows: Nd: 25.0 mass %, Pr: 4.7 mass %, Co: 1.4 mass %, B: 0.98 mass %, Al: 0.2 mass %, Cu: 0.1 mass %, Ga: 0.2 mass %, Zr: 0.1 mass %, C: 0.04 mass %, O: 0.04 mass %, N: 0.03 mass %, and Fe: the balance (excluding inevitable impurities and the like). Rare earth elements included in the RFeB-based magnet powder (and the sintered body of the RFeB-based alloy produced from the powder and base material) are only the above-described Nd and Pr (29.66 mass % in total), and do not include heavy rare earth element. The base material has low content of C of 0.10 mass % or less and low content of O of 0.10 mass % or less, or has further low content of C of 0.05 mass % or less and further low content of O of 0.05 mass % or less. Accordingly, by performing a grain boundary diffusion process described below using the base material, diffusion of the heavy rare earth element R_{Hd} to be diffused into the base material through a grain boundary of the base material can be prevented from being hindered by C and O, so that the heavy rare earth element R_{Hd} to be diffused easily spreads to the vicinity of a surface of a crystal grain in the base material, and thus a coercivity can be further improved.

In each of Examples 1 to 3, as the alloy for grain boundary diffusion process, an R_{Hd}Cu (TbCu) alloy in which Tb was used as the heavy rare earth element R_{Hd} to be diffused and contents of Tb and Cu were within the range of the present embodiment was prepared. As alloys for grain boundary diffusion process in Comparative Examples, a TbCu alloy having a content of Cu lower than that in the present embodiment (Comparative Examples 1 and 2), a TbCu alloy having a content of Cu higher than that in the present embodiment (Comparative Examples 3 and 4), an alloy including only Tb (Comparative Example 5), a TbAl alloy including only Tb and Al (including no Cu) (Comparative Example 6), and a TbCuAl alloy including Tb, Cu, and Al (Comparative Example 7) were prepared. Compositions of the alloys for grain boundary diffusion process in Examples and Comparative Examples are shown in Table 1. Table 1 also shows crushing efficiency (to be described later) for a part of alloys for grain boundary diffusion process.

TABLE 1

| | | | | Crushing | |
|---|---|---|---|---|---|
| | Content (mass %) | | | efficiency | |
| | Tb | Cu | Al | (%) | Remark |
| Example 1 | 80.0 | 20.0 | 0.0 | 95.3 | |
| Example 2 | 70.0 | 30.0 | 0.0 | 70.7 | |
| Example 3 | 60.0 | 40.0 | 0.0 | 44.4 | |
| Comparative | 95.5 | 4.5 | 0.0 | | Low content of Cu |
| Example 1 | | | | | |
| Comparative | 85.0 | 15.0 | 0.0 | | Low content of Cu |
| Example 2 | | | | | |
| Comparative | 55.0 | 45.0 | 0.0 | | High content of Cu |
| Example 3 | | | | | |
| Comparative | 50.0 | 50.0 | 0.0 | 12.9 | High content of Cu |
| Example 4 | | | | | |
| Comparative | 100.0 | 0.0 | 0.0 | 40.5 | No Cu |
| Example 5 | | | | | |
| Comparative | 92.7 | 0.0 | 7.2 | 52.8 | No Cu, with Al |
| Example 6 | | | | | |
| Comparative | 75.4 | 18.7 | 5.9 | 64.4 | Low content of Cu, |
| Example 7 | | | | | with Al |

The alloys for grain boundary diffusion process in Examples and Comparative Examples were produced as a powdered alloy for grain boundary diffusion process by producing an alloy ingot with arc melting, followed by crushing the alloy ingot with the following method. First, the alloy ingot was heated to a temperature in a range of 400° C. to 500° C. in a hydrogen atmosphere, thereby causing the alloy ingot to absorb hydrogen. By absorbing hydrogen in this way, the alloy ingot becomes brittle. Next, hydrogen was desorbed from the hydrogen-absorbed alloy ingot by heating the alloy ingot to a temperature in a range of 400° C. to 500° C. in a vacuum. Thereafter, the alloy ingot was crushed with a jet mill under a nitrogen atmosphere, and particles crushed to a predetermined particle diameter or less were collected to obtain a powder of the alloy for grain boundary diffusion process having a median particle diameter of about 10 m.

The crushing efficiency shown in Table 1 is a ratio determined by dividing a mass of the powder collected after being crushed to a predetermined particle diameter or less with the jet mill by a mass of the alloy ingot fed into the jet mill, expressed as a percentage. The crushing efficiency decreases as the content of Cu increases, and in Comparative Example 4 (Tb: 50 mass %, Cu: 50 mass %), the crushing efficiency is only 12.9%. In the present embodiment (Examples 1 to 3), since the content of Cu is 40 mass % or less, the crushing efficiency can be made higher than that in Comparative Example 4.

Adhesion substances were produced by mixing the powders of the alloys for grain boundary diffusion process in Examples 1 to 3 and Comparative Examples 1 to 3 and 5 to 7 obtained as described above with silicone grease (subsequent experiments were not conducted for Comparative Example 4, which had low crushing efficiency). The adhesion substance was applied to two surfaces (surface of 24 mm×15 mm) of a base material which is a rectangular parallelepiped body. A coating amount of the adhesion substance was adjusted such that a total mass of Tb included in the adhesion substance on the two surfaces of the base material was 0.8% of the mass of the base material in all Examples and Comparative Examples.

Then, for each Example and Comparative Examples 1 to 3 and 5 to 7, the base material to which the adhesion substance had been adhered was heated to a temperature of 915° C. and held for 30 hours to perform the grain boundary diffusion process. Further, after heating at 400° C. to 500° C. for 30 minutes as an aging treatment, the two surfaces to which the adhesion substance was adhered were ground by 0.15 mm to form a rectangular parallelepiped body of 24 mm×15 mm×9.1 mm, and finally cut into a rectangular parallelepiped body of 7 mm×7 mm×9.1 mm to thereby obtain an RFeB-based sintered magnet.

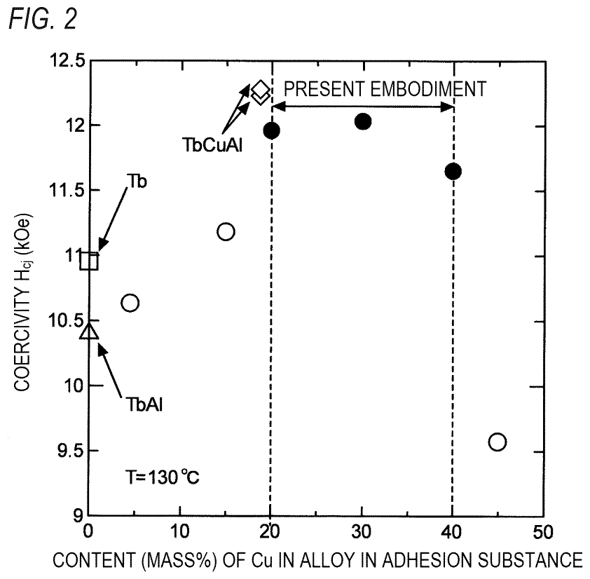

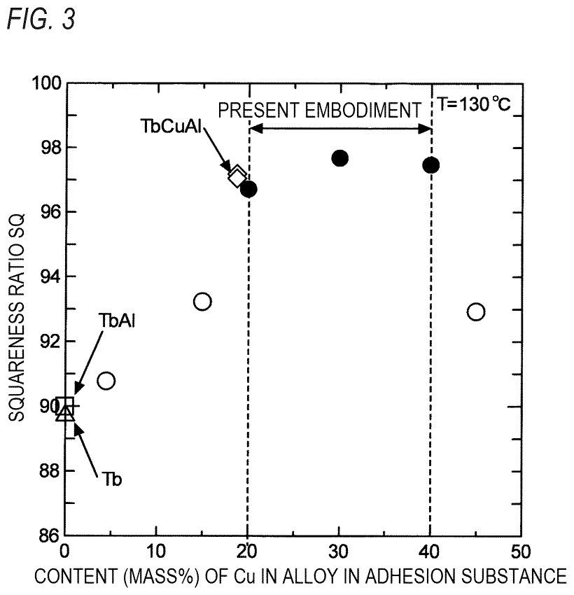

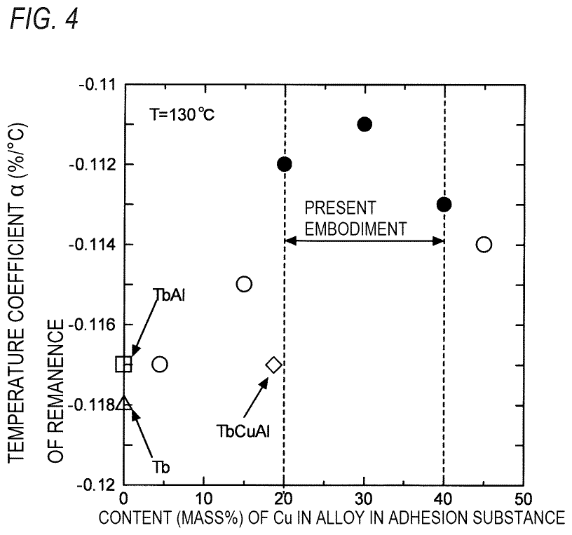

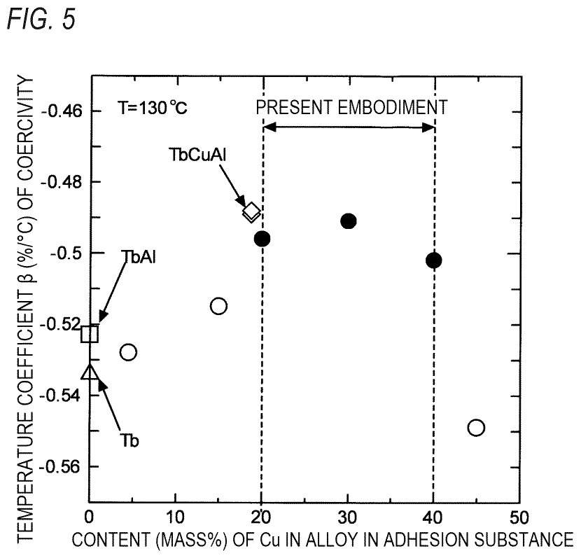

With respect to the RFeB-based sintered magnets obtained in each Example and Comparative Examples 1 to 3 and 5 to 7, various magnetic properties were measured at 130° C., which corresponds to the temperature during use of a drive motor for a car (in addition, for Comparative Example 7, measurements were made for two RFeB-based sintered magnets from different production lots). The measured magnetic properties are a remanence Bᵣ, a coercivity H_{cj}, a squareness ratio SQ(=Hₖ/H_{cj}), a temperature coefficient α of remanence, and a temperature coefficient β of coercivity. The values of the obtained magnetic properties are shown in Table 2. Relationship between a content of Cu and each magnetic property of the used alloy for grain boundary diffusion process are shown in graphs in FIG. 1 for the remanence Bᵣ, FIG. 2 for the coercivity H_{cj}, FIG. 3 for the squareness ratio SQ, FIG. 4 for the temperature coefficient α of remanence, and FIG. 5 for the temperature coefficient β of coercivity. In each graph, Examples 1 to 3 are shown with black circles, and Comparative Examples 1 to 3 and 5 to 7 are shown with open symbols. Among the open symbols indicating Comparative Examples, an open circle mark indicates TbCu (the content of Cu is less than 20 mass % or exceeds 40 mass %, which is outside the range of the present embodiment), an open equilateral triangle mark indicates Tb alone, an open square mark indicates TbAl, and an open rhombus mark indicates TbCuAl, which are used as the alloys for grain boundary diffusion process.

TABLE 2

| | Magnetic properties at temperature of 130° C. | | | | | |
|---|---|---|---|---|---|---|
| | Bᵣ (kG) | H_{cj} (kOe) | SQ (%) | α (%/° C.) | β (%/° C.) | Remark |
| Example 1 | 12.52 | 11.96 | 96.70 | −0.112 | −0.496 | |
| Example 2 | 12.54 | 12.03 | 97.66 | −0.111 | −0.491 | |
| Example 3 | 12.55 | 11.65 | 97.45 | −0.113 | −0.502 | |
| Comparative | 12.46 | 10.63 | 90.76 | −0.117 | −0.528 | Low content of |
| Example 1 | | | | | | Cu |
| Comparative | 12.48 | 11.18 | 93.21 | −0.115 | −0.515 | Low content of |
| Example 2 | | | | | | Cu |
| Comparative | 12.51 | 9.57 | 92.91 | −0.114 | −0.549 | High content of |
| Example 3 | | | | | | Cu |
| Comparative | 12.45 | 10.40 | 89.71 | −0.118 | −0.534 | No Cu |
| Example 5 | | | | | | |
| Comparative | 12.43 | 10.95 | 89.98 | −0.117 | −0.523 | No Cu, with Al |
| Example 6 | | | | | | |
| Comparative | 12.41 | 12.23 | 97.18 | −0.117 | −0.489 | Low content of |
| Example 7 | 12.40 | 12.28 | 97.04 | −0.117 | −0.488 | Cu, with Al |

From experimental results, the remanence Bᵣ, the coercivity H_{cj}, and the squareness ratio SQ in Examples 1 to 3 were all higher than those in Comparative Examples 1 to 3 and 5 to 7 except for the coercivity H and the squareness ratio SQ in Comparative Example 7. In Comparative Example 7, the coercivity H was slightly larger than that in Examples 1 to 3, the squareness ratio SQ was slightly larger than that in Example 1, and the remanence Bᵣ was smaller than that in Examples 1 to 3 (and further smaller compared to other Comparative Examples). As described above, the coercivity H j and squareness ratio SQ of the RFeB-based sintered magnets in Examples 1 to 3 can be made larger than those of the RFeB-based sintered magnets in Comparative Examples at a high temperature (130° C.) while preventing a decrease in remanence Bᵣ. Particularly, when the content of Cu in the R_{Hd}Cu alloy (TbCu alloy) is 20 mass % to 30 mass % (Examples 1 and 2), the coercivity H becomes significantly high. On the other hand, when the content of Cu in the R_{Hd}Cu alloy (TbCu alloy) is 30 mass % to 40 mass % (Examples 2 and 3), the remanence Bᵣ increases (while preventing the decrease in coercivity H_{cj}).

The temperature coefficient α of remanence at 130° C. has a negative value in both Examples and Comparative Examples. This is because the value of the remanence decreases as the temperature increases. The absolute value of the obtained α is smaller in Example 1 to 3 than in Comparative Examples 1 to 3 and 5 to 7. A small absolute value of α means that when a temperature change occurs around 130° C., the change in remanence Bᵣ is small and stable. Since the absolute value of α is large in Comparative Examples, particularly, in Comparative Examples 1, 2, and 5 to 7 in which the content of Cu in the alloy for grain boundary diffusion process is less than 20 mass %, α can be more significantly improved by setting the content of Cu to 20 mass % or more.

The temperature coefficient β of coercivity at 130° C. has a negative value in both Examples and Comparative Examples, as in the case of a, indicating that the value of the coercivity decreases as the temperature increases. The absolute value of β is smaller in Examples 1 to 3 than in Comparative Examples 1 to 3, 5, and 6. A small absolute value of 3 means that when a temperature change occurs around 130° C., the change in coercivity Hₑj is small and stable. Since the absolute value of β in Comparative Examples, particularly, in Comparative Example 3 in which the content of Cu in the alloy for grain boundary diffusion process exceeds 40 mass % is large, β can be more significantly improved by setting the content of Cu to 40 mass % or less. In Comparative Example 7, the absolute value of β is slightly smaller than that in Examples 1 to 3, but the absolute value of a is larger than that in Examples 1 to 3 (and further larger compared to Comparative Example 2 in which the content of Cu in the alloy for grain boundary diffusion process is smaller).

The present invention is not limited to the above-described embodiment and Examples, and various modifications are possible. For example, the TbCu alloy including only Tb as a heavy rare earth element is used as the alloy for grain boundary diffusion process in the above Examples, but an R_{Hd}Cu alloy including only Dy, only Ho, Tb and Dy, Tb and Ho, Dy and Ho, or Tb, Dy, and Ho as heavy rare earth elements may be used as the alloy for grain boundary diffusion process.

In the above Examples, a mixture of an R_{Hd}Cu alloy powder and silicone grease was adhered to the base material as an adhesion substance, but a mixture of the powder and grease other than silicone grease or a liquid may also be used as the adhesion substance. The grain boundary diffusion process may be performed by using a foil-shaped R_{Hd}Cu alloy or an ingot-shaped R_{Hd}Cu alloy as the adhesion substance instead of the R_{Hd}Cu alloy powder, and heating the adhesion substance in a state of being adhered to (brought into contact with) the base material.

In the above Examples, the base material prepared from the RFeB-based magnet powder having a specific composition was used, but the composition of the RFeB-based magnet powder is not limited to the above Examples. For example, a base material produced from an RFeB-based magnet powder including a heavy rare earth element may be used. The RFeB-based sintered magnet was used as the base material in the above Examples, but an RFeB-based hot-deformed magnet may be used as the base material.

The present application is based on Japanese Patent Application No. 2023-084189 filed on May 22, 2023, and the contents thereof are incorporated herein by reference.

What is claimed is:

1. A method for producing an RFeB-based magnet, the method comprising:
a base material preparation step of preparing a base material made of a sintered body of an RFeB-based alloy comprising a rare earth element R, Fe, and B or a hot-deformed body of the RFeB-based alloy;
an adhesion substance preparation step of preparing an adhesion substance containing an R_{Hd}Cu alloy that comprises Cu and a heavy rare earth element R_{Hd} to be diffused and that has a content of Cu of 20 mass % or more and 40 mass % or less, the heavy rare earth element R_{Hd} to be diffused being any one of or a mixture of two or more of Dy, Tb, and Ho;
an adhesion step of adhering the adhesion substance to a surface of the base material; and
a heating step of heating the base material to which the adhesion substance has been adhered to a predetermined temperature at which the heavy rare earth element R_{Hd} to be diffused is diffused into the base material through a grain boundary of the base material.

2. The method for producing an RFeB-based magnet according to claim 1, wherein
the adhesion substance comprises a powder of the R_{Hd}Cu alloy.

3. The method for producing an RFeB-based magnet according to claim 1, wherein
the base material has a content of C of 0.10 mass % or less and a content of O of 0.10 mass % or less.

4. The method for producing an RFeB-based magnet according to claim 2, wherein
the base material has a content of C of 0.10 mass % or less and a content of O of 0.10 mass % or less.

5. An alloy for grain boundary diffusion process, comprising an R_{Hd}Cu alloy that comprises Cu and a heavy rare earth element R_{Hd} to be diffused, and that has a content of Cu of 20 mass % or more and 40 mass % or less, wherein
the heavy rare earth element R_{Hd} to be diffused is any one of or a mixture of two or more of Dy, Tb, and Ho, and
the grain boundary diffusion process comprises adhering the alloy for grain boundary diffusion process to a base material made of a sintered body of an RFeB-based alloy comprising a rare earth element R, Fe, and B or a hot-deformed body of the RFeB-based alloy, followed by heating the base material to a predetermined temperature, to thereby diffuse the heavy rare earth element R_{Hd} to be diffused into the base material through a grain boundary of the base material.
